(19) United States
(12) Patent Application Publication
(10) Pub. No.: US 2026/0002883 A1
(43) Pub. Date: Jan. 1, 2026

(54) AI IDENTIFICATION AND DETECTION SYSTEM OF DEFECTIVE PRODUCTS IN THE PIPELINE TRANSPORTATION PROCESS OF FRUIT VESICLES

(71) Applicant: Swire Coca-Cola Beverages Guangxi Limited, Nanning (CN)

(72) Inventors: Fang Feng, Nanning (CN); Tianfu Zhong, Nanning (CN); Caishi Yan, Nanning (CN); Wei Hu, Nanning (CN); Wancun Huang, Nanning (CN)

(21) Appl. No.: 19/004,149

(22) Filed: Dec. 27, 2024

(30) Foreign Application Priority Data
Jun. 29, 2024 (CN) 2024108631231

(51) Int. Cl. G01N 21/88; G06T 7/00; G06T 7/62; G06V 20/68

(52) U.S. Cl. CPC G01N 21/8851; G06T 7/0004; G06T 7/62; G06V 20/68; G01N 2021/8854; G06T 2207/30128

(57) ABSTRACT

An AI identification and detection system of defective products in the pipeline transportation process of fruit vesicles comprises an orange vesicle information collection module, an vesicle quality qualification degree analysis module, a database, a vesicle disqualification processing module, and an orange vesicle quality problem feedback module; the invention comprehensively analyzes the vesicle quality qualification degree of orange vesicles by analyzing three dimensions of vesicle diameter conformity degree, vesicle freshness degree and vesicle contamination degree, which improves the analysis comprehensiveness of vesicle quality of orange vesicles, and through comprehensive analysis of three dimensions, it improves the strictness of quality control in the production process, and at the same time improves the stability of the product quality, reduces the return rate of goods and complaints from customers, and reduces the impact on economic benefits and reputation of enterprises.

### 1. TECHNICAL FIELD

The invention relates to the technical field of AI identification and detection of defective products in the pipeline transportation process of fruit vesicles, and more specifically, relates to an AI identification and detection system of defective products in the pipeline transportation process of fruit vesicles.

### 2. BACKGROUND ART

In the production and processing of orange vesicles, the transportation of vesicles is one of the key links. However, the traditional method of detecting defective orange vesicles mainly relies on manual visual inspection, which has the problems of low efficiency, high labor intensity, high cost and human error. With the continuous development of artificial intelligence technology, AI image recognition technology provides a new solution for the detection of defective orange vesicles, therefore, in order to guarantee the quality of orange vesicles and reduce the problems existing in the process of manual visual inspection, it is necessary to carry out AI recognition detection of defective orange vesicles in the pipeline transportation process.

The existing AI identification and detection of defective orange vesicles in the pipeline transportation process still has the following problems:
1. the current analysis is conducted only in a single dimension manner, not combined with the vesicle diameter, vesicle freshness and vesicle contamination, which reduces the comprehensiveness of the analysis of the quality of the vesicles, without comprehensive analysis of three dimensions, the quality control in the production process may not be strict enough, which may lead to unstable product quality, increase the rate of return and customer complaints, and affect the economic efficiency and reputation of the enterprise;
2. after collecting orange vesicles with unqualified vesicle quality, they are not reprocessed, i.e., they are directly discarded without being screened again for identification and testing, which may lead to a waste of resources and an increase in production costs, and at the same time, without being screened again for identification and detection, it is impossible to obtain the capacity of vesicles with serious quality failure, which reduces the accuracy of quality qualification analysis of the current capacity of orange vesicles and fails to provide effective improvement measures for the subsequent production and quality control.

### 3. SUMMARY OF THE INVENTION

In view of the above, in order to solve the problems raised in the above mentioned background art, the invention provides an AI identification and detection system of defective products in the pipeline transportation process of fruit vesicles.

The purpose of the invention can be achieved by the following technical solution: the invention provides an AI identification and detection system of defective products in the pipeline transportation process of fruit vesicles, comprising: an orange vesicle information collection module, used to divide the orange vesicles of current capacity into orange vesicle delivery segments according to the preset capacity, and carry out pipeline transportation for the orange vesicle delivery segments according to the set time intervals to collect humidity and images of the orange vesicle delivery segments through the pipeline at each monitoring point, so as to get image information of the orange vesicle delivery segments corresponding to each monitoring point.

A vesicle quality qualification degree analysis module is used to extract corresponding specified diameter range of orange vesicles, and analyze vesicles' quality qualification of each orange vesicle delivery segment.

A database is used to store the color set corresponding to fresh orange vesicles and the gray value range corresponding to clean orange vesicles.

A vesicle disqualification processing module is used to analyze whether the vesicle quality of each orange vesicle delivery segment is qualified by comparison, and carry out processing again for the orange vesicle delivery segment with unqualified vesicles.

An orange vesicle quality problem feedback module is used to analyze the quality qualification degree corresponding to the orange vesicles of current capacity and compare it with a set value, if it is less than the set value, it indicates that there is a serious quality problem in the orange vesicles of current capacity, and provide feedback.

Compared with the prior art, the beneficial effects of the invention are as follows:
(1) the invention comprehensively analyzes the vesicle quality qualification degree of orange vesicles by analyzing three dimensions of vesicle diameter conformity degree, vesicle freshness degree and vesicle contamination degree, which improves the analysis comprehensiveness of vesicle quality of orange vesicles, and through comprehensive analysis of three dimensions, it improves the strictness of quality control in the production process, and at the same time improves the stability of the product quality, reduces the return rate of goods and complaints from customers, and reduces the impact on economic benefits and reputation of enterprises.
(2) The invention can avoid waste of resources and reduce production cost by processing the orange vesicle delivery segments with unqualified vesicles again, and at the same time, it can get capacity of seriously unqualified vesicles again by sieving and identifying, which improves analysis accuracy of the quality qualification of the orange vesicles corresponding to the current capacity, and provides effective improvement measures for the subsequent production and quality control.

### 4. BRIEF DESCRIPTION OF ACCOMPANY DRAWINGS

In order to illustrate the preferred embodiment of the invention or the technical scheme more clearly, the drawings required by the embodiment is further described briefly. Obviously, only partial embodiments of the invention are shown and the actual structure is not limited thereto. It is to be understood by those skilled in the art that other drawings can be obtained based on the drawings of the invention with non-creative labor.

FIG. 1 is a connection diagram of system modules provided by the invention.

### 5. SPECIFIC EMBODIMENT OF THE INVENTION

The technical scheme of the invention is further described clearly and detailedly hereinafter with reference to the drawings. Obviously, only partial embodiments of the invention are shown and the actual structure is not limited thereto. All other embodiments, which can be obtained by those skilled in the art without making any creative effort based on the embodiments in the present invention, shall all fall within the protective scope of the invention.

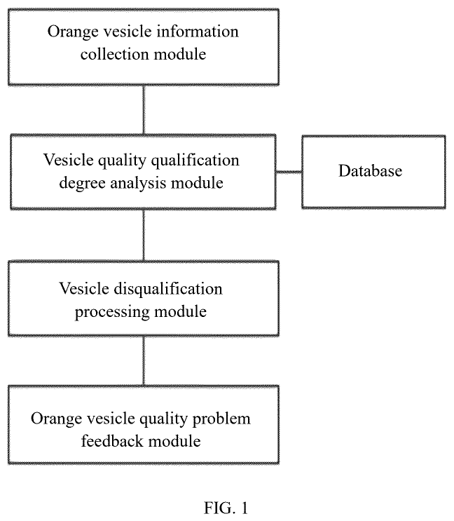

Referring to FIG. 1, the invention provides an AI identification and detection system of defective products in the pipeline transportation process of fruit vesicles, comprising: an orange vesicle information collection module, an vesicle quality qualification degree analysis module, a database, a vesicle disqualification processing module, and an orange vesicle quality problem feedback module.

The orange vesicle information collection module is connected to the vesicle quality qualification degree analysis module, the vesicle quality qualification degree analysis module is connected to the vesicle disqualification processing module, the vesicle disqualification processing module is connected to the orange vesicle quality problem feedback module, and the vesicle quality qualification degree analysis module is connected to the database.

The orange vesicle information collection module is used to divide the orange vesicles of current capacity into orange vesicle delivery segments according to the preset capacity, and carry out pipeline transportation for the orange vesicle delivery segments according to the set time intervals to collect humidity and images of the orange vesicle delivery segments at each monitoring point through the pipeline, so as to get image information of the orange vesicle delivery segments corresponding to each monitoring point.

In a specific embodiment of the invention, the image information includes number of orange vesicles, gray value of each grayscale area, and diameter and color of each orange vesicle.

It is to be noted that the humidity of each orange vesicle delivery segment through the conveying pipeline at all monitoring points is collected by a humidity sensor placed at each monitoring point in the conveying pipeline, and the number of vesicles, the diameter and color of each orange vesicle are located from the collected images.

It should also be noted that the gray values of the grayscale areas corresponding to each orange vesicle delivery segment at each monitoring point are collected in the following manner: the collected images of each orange vesicle delivery segment corresponding to each monitoring point are imported into a computer, and processed and analyzed by using an image processing software to obtain a grayscale image of each orange vesicle delivery segment at each monitoring point, and then locate the gray value of each grayscale area from the grayscale image.

The vesicle quality qualification degree analysis module is used to extract corresponding specified diameter range of orange vesicles, and analyze vesicles' quality qualification degree of each orange vesicle delivery segment.

It should be noted that the specified diameter range of the orange vesicles is extracted from a manual of requirements for the production of orange vesicles.

In a specific embodiment of the invention, the specific process of analyzing the vesicle quality qualification degree of each orange vesicle delivery segment is as follows: extracting the number of orange vesicles, the gray value of each grayscale area, and the diameter and color of each orange vesicle from the image information corresponding to each orange vesicle delivery segment at each monitoring point, and accordingly calculating a vesicle diameter conformity degree Bi, a vesicle freshness degree xᵢ, and a vesicle contamination degree & of each orange vesicle delivery segment, respectively, wherein i denotes the serial number of the orange vesicle delivery segment, i=2, . . . , n.

In a specific embodiment of the invention, the specific process of calculating the vesicle diameter conformity degree of each orange vesicle delivery segment is as follows: a diameter of each orange vesicle of each orange vesicle delivery segment at each monitoring point is averaged to obtain a vesicle diameter of each orange vesicle delivery segment at each monitoring point, and denoted as dᵢⱼ, wherein j denotes the serial number of the monitoring point, j=1, 2, . . . , m.

The specified diameter range of orange vesicles is denoted as [d′,d′]

Calculate the vesicle diameter conformity degree βᵢⱼ for each orange vesicle delivery segment at each monitoring point,

$${β}_{ij} = \{ \begin{matrix}1 , & {d}^{′} \leq {d}_{ij} \leq {d}^{″} \\ 0 , & {d}^{′} > {d}_{ij} or {d}_{ij} > {d}^{″}\end{matrix}$$

If the vesicle diameter conformity degree of an orange vesicle delivery segment at all monitoring points is 1, then the vesicle diameter conformity degree of the orange vesicle delivery segment is denoted as φ₁, and if the vesicle diameter conformity degree of an orange vesicle delivery segment all monitoring points is 0, then the vesicle diameter conformity degree of the orange vesicle delivery segment is denoted as φ₂, and if the vesicle diameter conformity degree of an orange vesicle delivery segment is 0 at a certain monitoring point, the vesicle diameter conformity degree of the orange vesicle delivery segment is denoted as φ₃, and the vesicle diameter conformity degree of each orange vesicle delivery segment is thus obtained as βᵢ, wherein the value of βᵢ is φ₁ or φ₂ or φ₃, and φ₁>φ₂>φ₃.

In a specific embodiment of the invention, the value of φ₁ is 1, the value of φ₂ is 0, and the value of φ₃ is 0.5.

In a specific embodiment of the invention, the specific process of calculating the vesicle freshness degree of each orange vesicle delivery segment is as follows: the humidity of each orange vesicle delivery segment at each monitoring point is averaged to obtain the humidity of each orange vesicle delivery segment, and is recorded as &i.

Compare the color of each orange vesicle of each orange vesicle delivery segment at each monitoring point with the color set corresponding to fresh orange vesicles stored in the database, if the color of an orange vesicle of an orange vesicle delivery segment at a certain monitoring point is located in the color set corresponding to fresh orange vesicles, the orange vesicle is recorded as a fresh orange vesicle, count the number of fresh orange vesicles of each orange vesicle delivery segment at each monitoring point, and recorded as μᵢⱼ.

Record the number of orange vesicles of each orange vesicle delivery segment at each monitoring point as μᵢⱼ.

Calculate the vesicle freshness xᵢ of each orange vesicle delivery segment as:

$${χ}_{i} = \frac{Δε}{1 + \vert {ε}_{i} - {ε}^{′} \vert} * {a}_{1} + \frac{\frac{1}{m} {\sum }_{j = 1}^{m} {\frac{{μ}_{ij}}{{μ}_{ij}} - K}^{Fresh}}{K} * {a}_{2} ,$$

wherein, ε′, Δε and K represent the set referential humidity, humidity deviation and percentage of fresh orange vesicles number respectively, a₁ and a₂ represent weights of set humidity deviation and percentage of fresh orange vesicles number for the evaluation of vesicle freshness respectively, and m represents the number of monitoring points.

In a specific embodiment of the present invention, the value of a₁ is 0.5, and the value of a₂ is 0.5.

In a specific embodiment of the invention, the specific process of calculating the vesicle contamination degree of each orange vesicle delivery segment is as follows: comparing the gray value of each grayscale area of each orange vesicle delivery segment at each monitoring point with the gray value range corresponding to the clean orange vesicles stored in the database, and if the gray value of a grayscale area of a certain orange vesicle delivery segment at a certain monitoring point is not located in the gray value range corresponding to the clean orange vesicles, the area is recorded as a contaminated area, count the number of contaminated areas corresponding to each orange vesicle delivery segment at each monitoring point, and add them up to get the number of contaminated areas captured from each orange vesicle delivery segment.

If the number of contaminated areas captured from the orange vesicle delivery segment is 0, the vesicle contamination degree of the orange vesicle delivery segment is recorded as DING₁, if the number of contaminated areas captured from the orange vesicle delivery segment is not 0, the vesicle contamination degree of the orange vesicle delivery segment is recorded as DING₂, and thus the vesicle contamination degree of each orange vesicle delivery segment is obtained as δᵢ, wherein the value of δᵢ is either DING₁ or DING₂, with DING₁<DING₂.

In a specific embodiment of the invention, the value of DING₁ is 0 and the value of DING₂ is 1.

Calculating the vesicle quality qualification degree of each orange vesicle delivery segment Wᵢ,

$${ω}_{i} = ( {λ}_{1} , {λ}_{2} , {λ}_{3} ) ( \begin{matrix}{β}_{i} \\ {χ}_{i} \\ {δ}_{i}\end{matrix} )$$

wherein λ₁, λ₂ and λ₃ represent weights of the set vesicle diameter conformity degree, vesicle freshness degree, and vesicle contamination degree for the evaluation of vesicle quality qualification degree, respectively.

In a specific embodiment of the invention, the value of λ is 0.3, the value of λ₂ is 0.35, and the value of λ₃ is 0.35. Freshness is one of the most important indicators of the quality of orange vesicles, and fresh vesicles contain more nutrients and flavor substances, which provide better taste and nutritional value, and at the same time, the degree of contamination is directly related to the safety and hygienic condition of orange vesicles. Highly contaminated vesicles may contain harmful substances or microorganisms, which may pose a threat to human health. Therefore, vesicle freshness and vesicle contamination are more important in the process of analyzing the quality qualification degree of vesicles in each vesicle delivery segment.

The invention comprehensively analyzes the vesicle quality qualification degree of orange vesicles by analyzing three dimensions of vesicle diameter conformity degree, vesicle freshness degree and vesicle contamination degree, which improves the analysis comprehensiveness of vesicle quality of orange vesicles, and through comprehensive analysis of three dimensions, it improves the strictness of quality control in the production process, and at the same time improves the stability of the product quality, reduces the return rate of goods and complaints from customers, and reduces the impact on economic benefits and reputation of enterprises.

The database is used to store the color set corresponding to fresh orange vesicles and the gray value range corresponding to clean orange vesicles.

The sources of data in the database of this embodiment are shown in Table 1 below.

TABLE 1

| | | Store | |
|---|---|---|---|
| Data category | Data source | position | Usage |
| Color set | Provided by | Database | Assist in counting the |
| corresponding | orange | | number of fresh orange |
| to fresh orange | vesicle | | vesicles of each orange |
| vesicles | manufacturer | | vesicle delivery segment at |
| | | | each monitoring point |
| Gray value | Provided by | Database | Assist in counting the |
| range | orange | | number of contaminated |
| corresponding to | vesicle | | areas captured by the |
| clean orange | manufacturer | | orange vesicle delivery |
| vesicles | | | segment |

The vesicle disqualification processing module is used to analyze whether the vesicle quality of each orange vesicle delivery segment is qualified by comparison, and carry out processing again for the orange vesicle delivery segment with unqualified vesicles.

In a specific embodiment of the invention, whether the vesicle quality of each orange vesicle delivery segment is qualified is analyzed by comparing the vesicle quality qualification degree of each orange vesicle delivery segment with the set referential vesicle quality qualification degree, and if the qualification degree of the vesicle quality of a certain orange vesicle delivery segment is smaller than the set referential vesicle quality qualification degree, the vesicle quality of the certain orange vesicle delivery segment is unqualified.

In a specific embodiment of the invention, the specific process of re-treating the orange vesicle delivery segment with unqualified vesicle quality is as follows:
step 1: collect the orange vesicle delivery segments with unqualified vesicle quality, so as to obtain a capacity of orange vesicles with unqualified vesicle quality, and recorded as an initial unqualified vesicle capacity;
step 2: sieve the initial unqualified vesicle capacity into delivery segments in equal proportion, and carry out pipeline transportation for the orange vesicle delivery segments according to the set time intervals to collect humidity and images of the orange vesicle delivery segments at each monitoring point through the pipeline, so as to get image information of the orange vesicle delivery segments corresponding to each monitoring point, and the vesicle quality qualification degree of each orange vesicle delivery segment is analyzed according to the analysis method of the vesicle quality qualification degree of each orange vesicle delivery segment.

It should be noted that the image information includes number of orange vesicles, gray value of each grayscale area, and diameter and color of each orange vesicle.
Step 3: comparing the vesicle quality qualification degree of each orange vesicle delivery segment with the set referential vesicle quality qualification degree, and if the qualification degree of the vesicle quality of a certain orange vesicle delivery segment is smaller than the set referential vesicle quality qualification degree, then the delivery segment is recorded as an unqualified delivery segment, accordingly confirming the seriously unqualified vesicle capacity.

In a specific embodiment of the invention, the process of confirming capacity of the seriously unqualified vesicle capacity is as follows: step 1, extract the vesicle quality qualification degree of each unqualified delivery segment, and make a difference with the set referential vesicle quality qualification degree to obtain the vesicle quality qualification deviation of each unqualified delivery segment.
Step 2: compare the vesicle quality qualification deviation of each unqualified delivery segment with the set referential vesicle quality qualification deviation, and if the vesicle quality qualification deviation of an unqualified delivery segment is larger than the set referential vesicle quality qualification deviation, the unqualified delivery segment is recorded as a seriously unqualified delivery segment, and all seriously unqualified delivery segments are collected to obtain the seriously unqualified vesicle capacity.

The orange vesicle quality problem feedback module is used to analyze the quality qualification degree corresponding to the orange vesicles of current capacity and compare it with a set value, if it is less than the set value, it indicates that there is a serious quality problem in the orange vesicles of current capacity, and provide feedback.

In a specific embodiment of the invention, the process of analyzing the quality qualification degree corresponding to the orange vesicles of current capacity is as follows: the capacity of the seriously unqualified vesicle capacity is denoted as Tₛₑᵣᵢₒᵤₛ.

The current orange vesicle capacity is denoted as T_{current}.

Calculate the quality qualification degree corresponding to the orange vesicles of current capacity ξ, and

$$ζ = {( \frac{1}{e} )}^{\frac{\frac{{T}_{serious}}{{T}_{current}} - σ}{σ}} ,$$

wherein σ denotes the set referential percentage of the seriously unqualified vesicle capacity, and e denotes a natural constant.

The embodiment of the invention can avoid waste of resources and reduce production cost by processing the orange vesicle delivery segments with unqualified vesicles again, and at the same time, it can get capacity of seriously unqualified vesicles again by sieving and identifying, which improves analysis accuracy of the quality qualification of the orange vesicles corresponding to the current capacity, and provides effective improvement measures for the subsequent production and quality control.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. An AI identification and detection system of defective products in the pipeline transportation process of fruit vesicles, comprising:
an orange vesicle information collection module, used to divide the orange vesicles of current capacity into orange vesicle delivery segments according to the preset capacity, and carry out pipeline transportation for the orange vesicle delivery segments according to the set time intervals to collect humidity and images of the orange vesicle delivery segments at each monitoring point through the pipeline, so as to get image information of the orange vesicle delivery segments corresponding to each monitoring point;
a vesicle quality qualification degree analysis module, used to extract corresponding specified diameter range of orange vesicles, and analyze vesicles' quality qualification of each orange vesicle delivery segment;
a database, used to store the color set corresponding to fresh orange vesicles and the gray value range corresponding to clean orange vesicles;
a vesicle disqualification processing module, used to analyze whether the vesicle quality of each orange vesicle delivery segment is qualified by comparison, and carry out processing again for the orange vesicle delivery segment with unqualified vesicles;
an orange vesicle quality problem feedback module, used to analyze the quality qualification degree corresponding to the orange vesicles of current capacity and compare it with a set value, if it is less than the set value, it indicates that there is a serious quality problem in the orange vesicles of current capacity, and provide feedback.

2. The AI identification and detection system of defective products in the pipeline transportation process of fruit vesicles of claim 1, wherein the image information includes number of orange vesicles, gray value of each grayscale area, and diameter and color of each orange vesicle.

3. The AI identification and detection system of defective products in the pipeline transportation process of fruit vesicles of claim 2, wherein the specific process of analyzing the vesicle quality qualification degree of each orange vesicle delivery segment is as follows:
extracting the number of orange vesicles, the gray value of each grayscale area, and the diameter and color of each orange vesicle from the image information corresponding to each orange vesicle delivery segment at each monitoring point, and accordingly calculating a vesicle diameter conformity degree βᵢ, a vesicle freshness degree xᵢ, and a vesicle contamination degree δᵢ of each orange vesicle delivery segment, respectively, wherein i denotes the serial number of the orange vesicle delivery segment, i=2, . . . , n;
calculating the vesicle quality qualification degree of each orange vesicle delivery segment Wᵢ,
$${ω}_{i} = ( {λ}_{1} , {λ}_{2} , {λ}_{3} ) ( \begin{matrix}{β}_{i} \\ {χ}_{i} \\ {δ}_{i}\end{matrix} )$$
wherein λ₁, λ₂ and λ₃ represent weights of the set vesicle diameter conformity degree, vesicle freshness degree, and vesicle contamination degree for the evaluation of vesicle quality qualification degree, respectively.

4. The AI identification and detection system of defective products in the pipeline transportation process of fruit vesicles of claim 3, wherein the specific process of calculating the vesicle diameter conformity degree of each orange vesicle delivery segment is as follows:
a diameter of each orange vesicle of each orange vesicle delivery segment at each monitoring point is averaged to obtain a vesicle diameter of each orange vesicle delivery segment at each monitoring point, and denoted as dᵢⱼ, wherein j denotes the serial number of the monitoring point, j=1, 2, . . . , m;
the specified diameter range of orange vesicles is denoted as [d′, d″];
calculate the vesicle diameter conformity degree βᵢⱼ for each orange vesicle delivery segment at each monitoring point,
$${β}_{ij} = \{ \begin{matrix}1 , & {d}^{′} \leq {d}_{ij} \leq {d}^{″} \\ 0 , & {d}^{′} > {d}_{ij} or {d}_{ij} > {d}^{″}\end{matrix} ;$$
if the vesicle diameter conformity degree of an orange vesicle delivery segment at all monitoring points is 1, then the vesicle diameter conformity degree of the orange vesicle delivery segment is denoted as φ₁, and if the vesicle diameter conformity degree of an orange vesicle delivery segment all monitoring points is 0, then the vesicle diameter conformity degree of the orange vesicle delivery segment is denoted as φ₂, and if the vesicle diameter conformity degree of an orange vesicle delivery segment is 0 at a certain monitoring point, the vesicle diameter conformity degree of the orange vesicle delivery segment is denoted as φ₃, and the vesicle diameter conformity degree of each orange vesicle delivery segment is thus obtained as βᵢ, wherein the value of βᵢ is φ₁ or φ₂ or φ₃, and φ₁>φ₃>φ₂.

5. The AI identification and detection system of defective products in the pipeline transportation process of fruit vesicles of claim 4, wherein the specific process of calculating the vesicle freshness degree of each orange vesicle delivery segment is as follows: the humidity of each orange vesicle delivery segment at each monitoring point is averaged to obtain the humidity of each orange vesicle delivery segment, and is recorded as εᵢ;
compare the color of each orange vesicle of each orange vesicle delivery segment at each monitoring point with the color set corresponding to fresh orange vesicles stored in the database, if the color of an orange vesicle of an orange vesicle delivery segment at a certain monitoring point is located in the color set corresponding to fresh orange vesicles, the orange vesicle is recorded as a fresh orange vesicle, count the number of fresh orange vesicles of each orange vesicle delivery segment at each monitoring point, and recorded as μᵢⱼ;
record the number of orange vesicles of each orange vesicle delivery segment at each monitoring point as μᵢⱼ;
calculate the vesicle freshness xᵢ of each orange vesicle delivery segment as:
$${χ}_{i} = \frac{Δε}{1 + \vert {ε}_{i} - {ε}^{′} \vert} * {a}_{1} + \frac{\frac{1}{m} {\sum }_{j = 1}^{m} {\frac{{μ}_{ij}}{{μ}_{ij}} - K}^{Fresh}}{K} * {a}_{2} ,$$
wherein, ε′, Δε and K represent the set referential humidity, humidity deviation and percentage of fresh orange vesicles number respectively, a₁ and a₂ represent weights of set humidity deviation and percentage of fresh orange vesicles number for the evaluation of vesicle freshness respectively, and m represents the number of monitoring points.

6. The AI identification and detection system of defective products in the pipeline transportation process of fruit vesicles of claim 3, wherein the specific process of calculating the vesicle contamination degree of each orange vesicle delivery segment is as follows:
comparing the gray value of each grayscale area of each orange vesicle delivery segment at each monitoring point with the gray value range corresponding to the clean orange vesicles stored in the database, and if the gray value of a grayscale area of a certain orange vesicle delivery segment at a certain monitoring point is not located in the gray value range corresponding to the clean orange vesicles, the area is recorded as a contaminated area, count the number of contaminated areas corresponding to each orange vesicle delivery segment at each monitoring point, and add them up to get the number of contaminated areas captured from each orange vesicle delivery segment;
if the number of contaminated areas captured from the orange vesicle delivery segment is 0, the vesicle contamination degree of the orange vesicle delivery segment is recorded as DING₁, if the number of contaminated areas captured from the orange vesicle delivery segment is not 0, the vesicle contamination degree of the orange vesicle delivery segment is recorded as DING₂, and thus the vesicle contamination degree of each orange vesicle delivery segment is obtained as δᵢ, wherein the value of δᵢ is either DING₁ or DING₂, with DING₁<DING₂.

7. The AI identification and detection system of defective products in the pipeline transportation process of fruit vesicles of claim 3, wherein whether the vesicle quality of each orange vesicle delivery segment is qualified is analyzed by comparing the vesicle quality qualification degree of each orange vesicle delivery segment with the set referential vesicle quality qualification degree, and if the qualification degree of the vesicle quality of a certain orange vesicle delivery segment is smaller than the set referential vesicle quality qualification degree, the vesicle quality of the certain orange vesicle delivery segment is unqualified.

8. The AI identification and detection system of defective products in the pipeline transportation process of fruit vesicles of claim 7, wherein the specific process of re-treating the orange vesicle delivery segment with unqualified vesicle quality is as follows:
step 1: collect the orange vesicle delivery segments with unqualified vesicle quality, so as to obtain a capacity of orange vesicles with unqualified vesicle quality, and recorded as an initial unqualified vesicle capacity;
step 2: sieve the initial unqualified vesicle capacity into delivery segments in equal proportion, and carry out pipeline transportation for the orange vesicle delivery segments according to the set time intervals to collect humidity and images of the orange vesicle delivery segments at each monitoring point through the pipeline, so as to get image information of the orange vesicle delivery segments corresponding to each monitoring point, and the vesicle quality qualification degree of each orange vesicle delivery segment is analyzed according to the analysis method of the vesicle quality qualification degree of each orange vesicle delivery segment;
step 3: comparing the vesicle quality qualification degree of each orange vesicle delivery segment with the set referential vesicle quality qualification degree, and if the qualification degree of the vesicle quality of a certain orange vesicle delivery segment is smaller than the set referential vesicle quality qualification degree, then the delivery segment is recorded as an unqualified delivery segment, accordingly confirming the seriously unqualified vesicle capacity.

9. The AI identification and detection system of defective products in the pipeline transportation process of fruit vesicles of claim 8, wherein the process of confirming capacity of the seriously unqualified vesicle capacity is as follows:
step 1, extract the vesicle quality qualification degree of each unqualified delivery segment, and make a difference with the set referential vesicle quality qualification degree to obtain the vesicle quality qualification deviation of each unqualified delivery segment;
step 2: compare the vesicle quality qualification deviation of each unqualified delivery segment with the set referential vesicle quality qualification deviation, and if the vesicle quality qualification deviation of an unqualified delivery segment is larger than the set referential vesicle quality qualification deviation, the unqualified delivery segment is recorded as a seriously unqualified delivery segment, and all seriously unqualified delivery segments are collected to obtain the seriously unqualified vesicle capacity.

10. The AI identification and detection system of defective products in the pipeline transportation process of fruit vesicles of claim 9, wherein the process of analyzing the quality qualification degree corresponding to the orange vesicles of current capacity is as follows:
the capacity of the seriously unqualified vesicle capacity is denoted as Tₛₑᵣᵢₒᵤₛ;
the current orange vesicle capacity is denoted as T_{current},
calculate the quality qualification degree corresponding to the orange vesicles of current capacity ξ, and
$$ζ = {( \frac{1}{e} )}^{\frac{\frac{{T}_{serious}}{{T}_{current}} - σ}{σ}} ,$$
wherein σ denotes the set referential percentage of the seriously unqualified vesicle capacity, and e denotes a natural constant.
